(19) United States
(12) Patent Application Publication
(10) Pub. No.: US 2011/0284160 A1
(43) Pub. Date: Nov. 24, 2011

(54) 2-Component Adhesives

(75) Inventors: PAUL BIRNBRICH, SOLINGEN (DE); HANS-JOSEF THOMAS, KORSCHENBROICH (DE); DAGMAR STAHLHUT-BEHN, ERKRATH (DE)

(73) Assignee: COGNIS IP MANAGEMENT GMBH, DUSSELDORF (DE)

(21) Appl. No.: 13/110,257

(22) Filed: May 18, 2011

(30) Foreign Application Priority Data
May 18, 2010 (EP) 10005173.9

(51) Int. Cl. B32B 37/12; C08L 63/00

(52) U.S. Cl. 156/330; 525/524

(57) ABSTRACT

The invention relates to 2-component adhesives comprising one or more epoxy resins as a first component (E) and one or more amphiphilic epoxy resin hardeners as a second component (H), wherein the first component (E) and the second component (H) are reacted in water in a phase inversion polymerization.

### CROSS-REFERENCE TO RELATED APPLICATIONS

This application claims the benefit of priority under 35 U.S.C. §119(a) to European Patent Application No. 10005173.9, filed May 18, 2010, which is hereby incorporated by reference in its entirety.

### BACKGROUND

The invention relates to specific 2-component adhesives. These adhesives comprise one or more epoxy resins as a first component (E) and one or more amphiphilic epoxy resin hardeners as a second component (H), with the proviso that the use of the adhesives involves reacting the two components (E) and (H) in water in a phase inversion polymerization, the cured adhesives being present, as a result, in the form of nanoporous polymer foams.

Background Information Polymeric epoxy resins are a long-established art. They are prepared, as a general rule, by reaction of polyepoxides having on average at least two epoxide end or side groups per molecule with hardeners, more particularly aminic hardeners, which are diamines or polyamines. These polymeric epoxy resins have diverse fields of application, predominant among which is their use as paints and coating materials (application of a top coat to a substrate).

EP-A-1518875 describes specific hardeners for water-based epoxy resin systems, said hardeners being obtainable by reacting a mixture of (a) at least one epoxidized polyalkylene oxide selected from the group consisting of epoxidized polyethylene oxides, epoxidized polypropylene oxides, and polyethylene-propylene oxides, (b) at least one epoxidized aromatic hydroxy compound selected from the group consisting of bisphenol A epoxides and bisphenol F epoxides, and (c) at least one aromatic hydroxy compound selected from the group consisting of bisphenol A and bisphenol F to form an intermediate and then reacting said intermediate with a polyamine. Also disclosed is the use of these hardeners for producing clear varnishes and coating materials (application of a top coat to a substrate, for floor coatings, for example).

EP-B-488949 describes a 2-component adhesive system based on a combination of epoxy resins and further formulating ingredients, as component 1, and also of a hardener component 2 composed of amine adducts along with additives for acceleration and adhesion promotion.

EP-A-2135909 likewise describes a 2-component adhesive system based on a formulation of epoxy resins featuring improved bond toughness.

US-A-2004/0258922 describes a water-based 1-component adhesive system where the epoxy resin component is encapsulated, for the adhesive bonding of screw connections.

The term “joining” according to DIN 8593 is used in manufacturing to denote the permanent connecting of at least two components. Joining creates the cohesion between the hitherto separate workpieces locally—that is, at the joints—and brings about a change in shape of the newly formed part. The connection here may be solid or movable in design. The operational forces that arise are transmitted via the active faces of the connection. The workpieces to be joined may be of a geometrically defined shape or else may be made of shapeless material. DIN 8593 classes joining into nine groups, in which the different joining techniques are assembled. One important joining technique among these is that of adhesive bonding.

DIN EN 923 defines an adhesive as a “nonmetallic material which is able to connect adherends by surface attachment (see adhesion) and internal strength (see cohesion)”.

With chemically hardening adhesives, often also called reactive adhesives, the individual chemical building blocks for the adhesive are introduced into the bond line in the correct proportion. Solidification is achieved through chemical reaction of the building blocks with one another. Among the reactive adhesives, a fundamental distinction is made between two-(or more-)component (pack, part) and one-component (pack, part) systems. Here, the 2-component epoxy adhesives constitute a particularly important class of the reactive 2-component adhesives.

### SUMMARY

It was an object of the present invention to provide new 2-component adhesives and a new method for adhesively bonding solid substrates.

The present invention first provides 2-component adhesives comprising one or more epoxy resins as first component (E) and one or more amphiphilic epoxy resin hardeners as second component (H), with the proviso that the use of the adhesives involves reacting the two components (E) and (H) in water in a phase inversion polymerization (PIP).

The present invention further provides a method for adhesively bonding solid substrates by locating between the adherend substrates an O/W emulsion comprising one or more epoxy resins (E) and one or more amphiphilic epoxy resin hardeners (H), the two components (E) and (H) being reacted in water in a phase inversion polymerization.

The cured adhesives of the present invention are present in the form of nanoporous polymer foams. By nanoporous polymer foams are meant polymers which have internal cavities. These are spongelike structures having both macropores and micropores, the micropores being predominant and having average cross sections in the range from 10 to 500 nm and more particularly from 10 to 100 nm.

The polymer foams that are formed in accordance with the invention when the 2-component adhesives are cured with reaction of the components (E) and (H) in a phase inversion polymerization are notable for low thermal conductivity with high mechanical strength. This makes the materials particularly attractive for use as structural, mechanically robust materials.

### DETAILED DESCRIPTION

### Phase Inversion Polymerization (PIP)

By phase inversion polymerization (PIP) is meant the following: First of all an aqueous emulsion of the epoxy resin (E) in water is prepared, the amphiphilic epoxy resin hardener (H) acting as an emulsifier. This system—also referred to below as reaction system—is referred to initially as an oil-in-water emulsion (O/W emulsion). The oil component of this O/W emulsion, of course, is the epoxy resin (E).

In the course of the subsequent reaction of resin and hardener (curing in the sense of a polyaddition) there is a phase inversion—that is, the reaction system changes from an O/W-type emulsion to a W/O-type emulsion, where the internal water phase is surrounded by the curing polymer. The reason for this is that, in the course of curing, the original emulsifier properties of the hardener undergo alteration, because polyaddition changes the nature of the hardener, making it increasingly hydrophobic.

After curing is complete, there is now a porous polymer matrix present, comprising the water phase in its cavities. The water phase can be removed, if desired, by drying, producing air-filled cavities.

A necessary precondition for a phase inversion polymerization to take place is that no water can escape from the reaction system. In the case of the adhesive bonding of solid substrates, this condition is met substantially by the fact, simply, that a large part of the reaction system is already confined by the solid substrates, and so, in any case, the only parts of the reaction system that are not delimited, and hence are open to the environment, are those not delimited by the substrate where bonding is to take place. The stated requirement may be realized, for instance, by the reaction system being present in a completely closed mold. It is also possible, in respect of those parts of the reaction system that are not confined by the solid substrates to be bonded, to ensure that (a) there is sufficient atmospheric humidity prevailing at the interface with the gas phase (surrounding air, usually), preventing dryout or loss of water from the upper layer of the reaction system, or that (b) the interface with the gas phase is covered, with a film, for example.

The fact that the cured systems are nanoporous structures is evident quite simply visually, from the fact that the materials obtained are white rather than being clear.

In one preferred embodiment, the PIP is carried out such that epoxy resin (E) and hardener (H) are used in an equivalents ratio of 2:1 to 1:2. In this context, (E) to (H) equivalents ratios of 1:1 are particularly preferred.

The PIP is characterized by an introductory phase, in which there is an O/W emulsion present, and a curing phase, whose beginning is defined by the formation of the W/O emulsion. The PIP may be carried out at 0% to 100% humidity. The water content of the PIP reaction system is set preferably to a value in the range from 5% to 95% by weight and more particularly in the range from 20% to 95% by weight (in each case based on the overall reaction system).

The reaction system can be cured within a broad temperature range, preferably between 1° C. and 99° C. and more particularly between 5° C. and 60° C.

If desired, thickeners may be added to the reaction system as well.

If desired, fillers may be added to the reaction system as well. For the use of selected fillers it is possible in this case to bring about further modification not only of the mechanical properties, such as compressive strength, flexural resistance, modulus of elasticity, and density, but also of the thermal conductivity of the nanoporous polymer foams of the invention.

If desired, additives such as, for example, adhesion promoters may be added to the reaction system, and improve the adhesion to the substrate to be bonded.

### The Epoxy Resins (E)

The epoxide compounds (E) are polyepoxides having on average at least two epoxide end or side groups per molecule. These epoxide compounds may be saturated or unsaturated, may be aliphatic, cycloaliphatic, aromatic or heterocyclic, and may also contain hydroxyl groups. They may additionally include substituents of a kind which, under the conditions of mixing and of reaction, do not give rise to disruptive side reactions, examples being alkyl or aryl substituents, ether moieties, and the like.

These epoxide compounds are preferably polyglycidyl ethers based on polyhydric alcohols, phenols, hydrogenation products of these phenols, and/or on novolaks (reaction products of monohydric or polyhydric phenols with aldehydes, more particularly formaldehyde, in the presence of acidic catalysts).

The epoxide equivalent weights of these epoxide compounds are preferably between 85 and 3200, more particularly between 170 and 830. The epoxide equivalent weight of a substance is defined as the amount of the substance (in grams) which contains 1 mol of oxirane rings.

Polyhydric phenols contemplated include preferably the following compounds: resorcinol, hydroquinone, 2,2-bis(4-hydroxyphenyl)propane (bisphenol A), isomer mixtures of dihydroxydiphenylmethane (bisphenol F), tetrabromobisphenol A, 4,4′-dihydroxydiphenylcyclohexane, 4,4′-dihydroxy-3,3-dimethyldiphenylpropane, 4,4′-dihydroxybiphenyl, 4,4′-dihydroxybenzophenol, 1,1-bis(4-hydroxyphenyl)ethane, 1,1-bis(4-hydroxy)isobutane, bis(4-hydroxyphenyl)methane, bis(4-hydroxyphenyl)ether, bis(4-hydroxyphenyl)sulfone, etc., and also the chlorination and bromination products of the aforementioned compounds; bisphenol A is especially preferred in this context.

The polyglycidyl ethers of polyhydric alcohols are also suitable as compounds (E). Examples of such polyhydric alcohols include ethylene glycol, diethylene glycol, triethylene glycol, 1,2-propylene glycol, polyoxypropylene glycols (n=1−20), 1,3-propylene glycol, 1,4-butylene glycol, 1,5-pentanediol, 1,6-hexanediol, 1,2,6-hexanetriol, glycerol, isosorbide, and 2,2-bis(4-hydroxycyclohexyl)propane.

It is also possible to use polyglycidyl esters of polycarboxylic acids as compounds (F), obtained through the reaction of epichlorohydrin or similar epoxy compounds with an aliphatic, cycloaliphatic or aromatic polycarboxylic acid, such as oxalic acid, succinic acid, adipic acid, glutaric acid, phthalic acid, terephthalic acid, hexahydrophthalic acid, 2,6-naphthalenedicarboxylic acid, and dimerized linolenic acid. Examples are diglycidyl adipate, diglycidyl phthalate, and diglycidyl hexahydrophthalate.

Mixtures of two or more epoxide compounds (E) may also be used.

With regard to the curing of the reaction system, for which, as stated above, the hardeners (H) for use in accordance with the invention are reacted in an aqueous medium with epoxide compounds (E) in a phase inversion polymerization (PIP), it is possible, optionally, to use additional processing assistants and/or adjuvants that are known appropriately to the skilled person. Examples of such are pigments, deaerators, defoamers, dispersing assistants, antisettling agents, accelerators, free amines, flow control additives, viscosity regulators, adhesiveness enhancers, tougheners, and conductivity improvers.

### The Epoxy Resin Hardeners (H)

Amphiphilic epoxy resin hardeners (H) are epoxy resin hardeners which have hydrophilic and hydrophobic structural elements.

Preference is given to using amphiphilic epoxy resin hardeners of a kind which are self-emulsifying in water at 25° C. and which, moreover, are capable of emulsifying epoxy resins (E) in water at 25° C.

Preference is given to employing those hardeners (H*) which are obtainable by reacting a mixture comprising

(A) at least one epoxidized polyalkylene oxide selected from the group consisting of epoxided polyethylene oxides, epoxidized polypropylene oxides, and polyethylene-propylene oxides,

(B) at least one epoxidized aromatic hydroxy compound selected from the group consisting of bisphenol A epoxides and bisphenol F epoxides, and

(C) at least one aromatic hydroxy compound selected from the group consisting of bisphenol A and bisphenol F

to form an intermediate (Z) and then reacting said intermediate with a polyamine (P).

In one embodiment, exclusively the components (A), (B), and (C) are reacted to form the intermediate (Z), which is then reacted further with a polyamine (P).

In another embodiment, the intermediate (Z) which is subsequently reacted with the polyamines (P) to give the hardener is prepared using, in addition to the compounds (A), (B) and (C), the compounds (D). The compounds (D) are compounds from the group consisting of the triglycidyl ethers of triols and the diglycidyl ethers of diols. Examples of suitable diols and triols which form a basis for the compounds (D) include the following: ethylene glycol, diethylene glycol, triethylene glycol, 1,2-propylene glycol, 1,3-propylene glycol, 1,4-butylene glycol, 1,5-pentanediol, 1,6-hexanediol, cyclohexanediol, cyclohexanedimethanol, neopentyl glycol, 1,2,6-hexanetriol, glycerol, and trimethylolpropane.

### The Compounds (A)

By epoxidized polyethylene oxides are meant, for the purposes of the invention, compounds obtainable by converting the two terminal OH groups of polyethylene oxide into oxirane groups, through reaction with epichlorohydrin, for example. The polyethylene oxide used here may have an average molar weight in the range from 80 to 3000; it can be prepared by polymerizing ethylene oxide starting from a C₂-C₁₈ alkylenediol, in a way with which the skilled person is familiar.

By epoxidized polypropylene oxides are meant, for the purposes of the invention, compounds obtainable by converting the two terminal OH groups of polypropylene oxide into oxirane groups, through reaction with epichlorohydrin, for example. The polypropylene oxide used here may have an average molar weight in the range from 110 to 3000; it can be prepared by polymerizing propylene oxide starting from a C₂-C₁₈ alkylenediol, in a way with which the skilled person is familiar.

By polyethylene-propylene oxides are meant, for the purposes of the invention, compounds which are obtainable by converting the two terminal OH groups of polyethylene-propylene oxide into oxirane groups, through reaction with epichlorohydrin, for example. The polyethylene-propylene oxide used here may have an average molar weight in the range from 80 to 3000. Polyethylene-propylene oxide compounds are those obtainable by copolymerization of ethylene oxide and propylene oxide, where the polymerization of the two reactants may be carried out simultaneously or in blocks, by polymerizing the propylene oxide and/or the ethylene oxide starting from a C₂-C₁₈ alkylenediol in a way with which the skilled person is familiar.

The compounds (A) may be used individually or in a mixture with one another.

### The Compounds (B)

By bisphenol A epoxides are meant, for the purposes of the invention, and as is generally customary, compounds obtainable by reacting bisphenol A with epichlorohydrin and polymerizing the product by further reaction with bisphenol A. These compounds are therefore also known under the name bisphenol A diglycidyl ethers or, generally, as epoxy resins. Commercial products are Epikote 828, 1001, 1002, 1003, 1004, etc. from Shell.

The molecular weights of the bisphenol A epoxides used are preferably in the range from 380 to 3000.

By bisphenol F epoxides are meant, for the purposes of the invention, and as is generally customary, compounds obtainable by reacting bisphenol F with epichlorohydrin and/or polymerizing the product by further reaction with bisphenol F. These compounds are therefore also known under the name bisphenol F diglycidyl ethers or, generally, as bisphenol F epoxy resins.

The molecular weights of the bisphenol F epoxides used are preferably in the ranger from 350 to 3000.

The compounds (B) can be used individually or in a mixture with one another.

### The Compounds (C)

Bisphenol A is known appropriately to the skilled person and is characterized by the following formula:

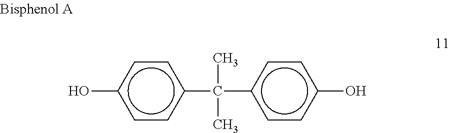

Bisphenol F is likewise known appropriately to the skilled person.

The compounds (C) can be used individually or in a mixture with one another.

### The Compounds (P)

Polyamines (P) employed are, for the purposes of the present invention, primary and/or secondary amines having at least two nitrogen atoms and at least two active amino hydrogen atoms per molecule. It is possible for aliphatic, aromatic, aliphatic-aromatic, cycloaliphatic, and heterocyclic diamines and polyamines to be utilized.

Examples of suitable polyamines (P) are as follows: polyethylenamines (ethylenediamine, diethylenetriamine, triethylenetetramine, tetraethylenepentamine, etc.), 1,2-propylenediamine, 1,3-propylenediamine, 1,4-butanediamine, 1,5-pentanediamine, 1,3-pentanediamine, 1,6-hexanediamine, 3,3,5-trimethyl-1,6-hexanediamine, 3,5,5-trimethyl-1,6-hexanediamine, 2-methyl-1,5-pentanediamine, bis(3-aminopropyl)amine, N,N′-bis(3-aminopropyl)-1,2-ethanediamine, N-(3-aminopropyl)-1,2-ethanediamine, 1,2-diaminocyclohexane, 1,3-diaminocyclohexane, 1,4-diaminocyclohexane, aminoethyl-piperazines, the poly(alkylene oxide) diamines and triamines (such as, for example, Jeffamine D-230, Jeffamine D-400, Jeffamine D-2000, Jeffamine D-4000, Jeffamine T-403, Jeffamine EDR-148, Jeffamine EDR-192, Jeffamine C-346, Jeffamine ED-600, Jeffamine ED-900, Jeffamine ED-2001), meta-xylylenediamine, phenylenediamine, 4,4′-diaminodiphenylmethane, toluenediamine, isophoronediamine, 3,3′-dimethyl-4,4′-diaminodicyclohexylmethane, 4,4′-diaminodicyclohexylmethane, 2,4′-diaminodicyclohexylmethane, 1,3-bis(aminomethyl)cyclohexane, the mixture of poly(cyclohexyl-aromatic)amines linked via a methylene bridge (also known as MBPCAA), and polyaminoamides. Polyethylenamines, more particularly diethylenetriamine, are particularly preferred.

The compounds (P) may be used individually or in a mixture with one another.

### The Preparation of the Intermediate (Z)

As stated above, the hardeners (H*) are obtainable by reacting a mixture comprising the compounds (A), (B) and (C) first to form an intermediate (Z), which is subsequently reacted with the polyamine (P). In one embodiment, when preparing the intermediate (Z), the compounds (A) and (B) are used in a molar ratio of 0.1:1 to 5:1.

In one embodiment, when preparing the intermediate (Z), a molar ratio of the sum of the compounds (A) and (B) (these compounds each contain two oxirane groups per molecule) to compound (C) (this compound contains two OH groups per molecule) in the range from 1.1:1 to 10:1 is set. This amounts to the same as setting the equivalents ratio of oxirane rings in the sum of the compounds (A) and (B) to reactive hydrogen atoms of the compound (C) to a level in the range from 1.1:1 to 10:1.

In a further embodiment, specifically in cases where a compound (D) is used as well in preparing the hardener, in the preparation of the intermediate (Z), a molar ratio of the sum of the compounds (A), (B) and (D) (these compounds each contain two oxirane groups per molecule) to compound (C) (this compound contains two OH groups per molecule) in the range from 1.1:1.0 to 10.0:1.0 is set. This amounts to the same as setting the equivalents ratio of oxirane rings in the sum of the compounds (A), (B), and (D) to reactive hydrogen atoms of the compound (C) to a level in the range from 1.1:1.0 to 10.0:1.0.

In this regard, for the sake of clarity, the following elucidation is provided: The expression “equivalents ratio” is familiar to the skilled person. The fundamental concept behind the notion of the equivalent is that consideration is given, for each substance involved in a reaction, to the reactive groups involved in the intended reaction. The statement of an equivalents ratio then expresses the numerical ratio between the entirety of the reactive groups of the compounds (x) and (y) that are used. It should be noted here that by a reactive group is meant the smallest possible reactive group—the notion of the reactive group is therefore not the same as the notion of the functional group. In the case of H-acidic compounds, for instance, this means that, while OH groups or NH groups are considered to constitute such reactive groups, NH₂ groups are not, having two reactive H atoms on the same nitrogen atom. Here, rationally, within the functional group NH₂, the two hydrogen atoms are considered the reactive group, and so the functional group NH₂ has two reactive groups, namely the hydrogen atoms.

In one embodiment, the intermediate (Z) is prepared in the presence of a catalyst, more particularly triphenylphosphine or ethyltriphenylphosphonium iodide. The amount of the catalyst in this case is around 0.01% to 1.0% by weight—based on the total amount of the compounds (A), (B), and (C).

The epoxide number (% EpO) of the intermediate (Z) is preferably below 10% EpO, more particularly below <5% EpO. The definition of the epoxide number and the details of its analytical determination may be found in the Examples section of this specification.

### The Preparation of the Hardener (H)

For the preparation of the hardener, the intermediate (Z), as already stated, is reacted with a polyamine (P).

In one embodiment the intermediate (Z) and the polyamine (P) are used in amounts such that the equivalents ratio of the reactive H atoms on the aminonitrogen atoms of (P) to the oxirane groups in the intermediate (Z) is in the range from 4:1 to 100:1.

The reaction of the intermediate (Z) with the polyamine is preferably carried out such that the polyamine is introduced in excess, thereby ensuring that substantially one molecule of the polyamine, preferably diethylenetriamine, reacts with in each case one of the epoxide groups of the intermediate (Z). Excess amine can be removed by distillation, in order to minimize the amount of free amine.

### The Solid Substrates to be Bonded

With regard to the solid substrates to be bonded, the present invention is not subject per se to any particular restrictions.

Thus, for example, the following solid substrates may be bonded to one another: metals, alloys, wood, glass, ceramic, plastics, mineral materials such as stone, concrete, and composite materials. Like materials and also different materials may be bonded to one another, e.g., wood/metal, wood/plastic, etc.

The materials to be bonded may be used as they are. Alternatively they may be used in the form of pretreated solid substrates. This means that their surfaces may have been modified by pretreatment. In principle it is possible to employ any of the pretreatments that are known appropriately to the skilled person. Examples of such pretreatments are, for instance, cleaning, washing, rinsing, abrading, application of conversion coats (e.g., phosphatizing), and priming with adhesion promoters that are customary in the adhesives art, more particularly with epoxysilanes and/or aminosilanes.

### EXAMPLES

### Abbreviations

The abbreviations used below have the following meanings:
EEW=epoxide equivalent weight (as described above)
MW=average molecular weight
rpm=revolutions per minute
%=percent by weight, unless explicitly indicated otherwise

### Raw Materials Used

Epoxy resin (E): Chem Res E20 (Cognis GmbH)
Hardener (H): the following hardeners were prepared:

### Preparation of Hardener H1:

44 g of poly(propylene glycol) diglycidyl ether (EEW: 326 and MW: 652) were mixed at 20 degrees Celsius with 46.2 g of bisphenol A diglycidyl ether (Chem Res E20 from Cognis, EEW: 194), 14.0 g of bisphenol A, and 0.1 g of triphenylphosphine. The resulting mixture was heated to 160° C. and stirred at this temperature for about 3.5 hours, until the epoxide number was 3.95%. It was then cooled to 60° C. and at this temperature 121.4 g of diethylenetriamine were added. After the exotherm had subsided, the reaction mixture was heated again at 160° C. for 2 hours.

The excess of diethylenetriamine was distilled off under reduced pressure (at a liquid-phase temperature of up to 200° C. and at pressures of less than 10 mbar) until free amine no longer distilled over. The mixture was then cooled to 90° C. and admixed with 89.5 g of water, with thorough stirring.

This gave 205.6 g of a clear, amber-colored liquid having a viscosity (undiluted, Brookfield, 10 rpm, 40° C.) of 2140 mPas, a solids content of 60%, and an amine number of 134.

### Examples 1-5

### Bonding Tests

Epoxy resins (E) and hardeners (H) were introduced into a stiffing beaker (diameter 95 mm, height 120 mm) and homogenized thoroughly using a wooden spatula. The amounts of (E) and (H) used are indicated in table 1. A homogeneous white coloration indicated appropriate homogenization. Then, in portions, the water was added (the amount of water in each case is indicated in table 1). The total time from preliminary emulsification to processing amounted to around 7 minutes.

For processing, an overlapping adhesive bond with an area of 625 mm² was produced on standard test specimens with dimensions of 100×25×4 mm. This means that the substrates were bonded to one another in such a way as to produce an overall length of the bonded test specimen of 175 mm, with an overlapping bond area of 25×25 mm² (=625 mm²). The bonds were fixed and were cured in a drying cabinet at 55° C. for 24 hours. After they had cooled to room temperature, a measurement was made of the tensile shear strength in accordance with ISO 4587. The results are set out in Table 1.

TABLE 1

| | Example | Example | Example | Example | Example |
|---|---|---|---|---|---|
| | 1 | 2 | 3 | 4 | 5 |
| Substrate | Beech | Beech | Aluminum | Steel | GRP |
| | | | | | epoxy |
| Pre- | none | none | abraded | abraded, | abraded |
| treatment | | | | primed¹⁾ | |
| | | | | with | |
| | | | | gamma- | |
| | | | | APS | |
| Hardener | 11.7 | 11.7 | 11.7 | 11.7 | 11.7 |
| H1 [g] | | | | | |
| Epoxy resin | 10.0 | 10.0 | 10.0 | 10.0 | 10.0 |
| Chem Res | | | | | |
| E20 [g] | | | | | |
| Fully | 1.8 | 0.0 | 0.0 | 0.0 | 0.0 |
| demin- | | | | | |
| eralized | | | | | |
| water [g] | | | | | |
| Binder | 72.4 | 78.4 | 78.4 | 78.4 | 78.4 |
| content²⁾ % | | | | | |
| Application | 0.6 | 0.6 | 0.5 | 0.6 | 0.6 |
| of adhesive | | | | | |
| [g] | | | | | |
| Curing | 55 | 55 | 55 | 55 | 55 |
| temperature | | | | | |
| [° C.] | | | | | |
| Curing | 24 | 24 | 24 | 24 | 24 |
| time [h] | | | | | |
| Film | 0.1 | 0.3-0.5 | 0.7-1.0 | 1.1-1.4 | 1.0 |
| thickness | | | | | |
| of bond | | | | | |
| [mm] | | | | | |
| Tensile | 7.05 | 5.25 | 1.46 | 5.83 | 4.91 |
| strength | | | | | |
| [MPa] | | | | | |
| Fracture | substrate | substrate | delam- | delam- | substrate |
| mode | fracture | fracture | ination | ination | fracture |
| | | | fracture | fracture | |

Notes relating to Table 1:
¹⁾ Priming with gamma-APS (gamma-aminopropyltrimethoxysilane): immersion of the bond areas in a 10% strength solution of g-APS in fully demineralized water for 30 minutes, followed by rinsing with water and drying at 60° C. for 60 minutes.
²⁾ The “binder content” line serves only for information. By binder here is meant, simply, the reaction product of hardener H1 and epoxy resin (Chem Res E20). The binder content, accordingly, is the fraction of the thus-defined binder as a percentage of the overall system. The calculation of the binder content may be demonstrated, for example, for example 1: since the reaction of epoxy resin with amine hardener (hardener H1) takes place as a polyaddition without elimination of molecular moieties, the mass fractions of resin and hardener can be added to give the amount of the resulting binder: the epoxy resin used, Chem Res E20, is considered on a 100% basis (10.0 g). The hardener H1 used, since it has a solids content of 60%, is taken into account only as 0.6 × 11.7 g = 7.02 g. Accordingly, the amount of the binder in the system comes out at 7.02 + 10.0 = 17.02 g. The overall system also contains 1.8 g of water, thus giving a total amount of 11.7 g + 10.0 g + 1.8 g = 23.5 g. The binder fraction in the overall system is calculated from this as follows: % binder = 17.02 × 100/23.5 = 72.4%.

1. A 2-component adhesive comprising one or more epoxy resins as a first component (E) and one or more amphiphilic epoxy resin hardeners as a second component (H), wherein the two components (E) and (H) are reacted in water in a phase inversion polymerization.

2. The 2-component adhesive as claimed in claim 1, wherein the component (H) of epoxy resin hardeners is obtainable by reacting a mixture comprising
(A) at least one epoxidized polyalkylene oxide selected from the group consisting of epoxidized polyethylene oxides, epoxidized polypropylene oxides, and polyethylene-propylene oxides,
(B) at least one epoxidized aromatic hydroxy compound selected from the group consisting of bisphenol A epoxides and bisphenol F epoxides, and
(C) at least one aromatic hydroxy compound selected from the group consisting of bisphenol A and bisphenol F
to form an intermediate and then reacting said intermediate with a polyamine (P).

3. The 2-component adhesive as claimed in claim 2, wherein the polyamine (P) comprises diethylenetriamine.

4. The 2-component adhesive as claimed in claim 2, wherein the component (A) comprises one or more epoxidized polypropylene oxides.

5. The 2-component adhesive as claimed in claim 2, wherein the component (B) comprises one or more bisphenol A epoxides.

6. The 2-component adhesive as claimed in claim 2, wherein component (C) comprises bisphenol A.

7. A method for adhesively bonding solid substrates by locating between the adherend substrates an O/W emulsion comprising one or more epoxy resins (E) and one or more amphiphilic epoxy resin hardeners (H), wherein the two components (E) and (H) are reacted in water in a phase inversion polymerization.

8. The method as claimed in claim 7, wherein component (H) is an epoxy resin hardener obtained by reacting a mixture comprising
(A) at least one epoxidized polyalkylene oxide selected from the group consisting of epoxidized polyethylene oxides, epoxidized polypropylene oxides, and polyethylene-propylene oxides,
(B) at least one epoxidized aromatic hydroxy compound selected from the group consisting of bisphenol A epoxides and bisphenol F epoxides, and
(C) at least one aromatic hydroxy compound selected from the group consisting of bisphenol A and bisphenol F
to form an intermediate (Z) and then reacting said intermediate (Z) with a polyamine (P).

9. The method as claimed in claim 8, wherein polyamine (P) comprises diethylenetriamine.

10. The method as claimed in claim 8, wherein component (A) comprises one or more epoxidized polypropylene oxides.

11. The method as claimed in claim 8, wherein component (B) comprises one or more bisphenol A epoxides.

12. The method as claimed in claim 8, wherein component (C) comprises bisphenol.

13. The method as claimed in claim 8, wherein the reaction system is cured in the temperature range from 1 to 99° C.

14. The method as claimed in claim 13, wherein the reaction system is cured in the temperature range from 5 to 60° C.

15. The method as claimed in claim 8, wherein the water content of the reaction system is adjusted to a value in the range from 5% to 95% by weight, based on the overall reaction system.

16. The 2-component adhesive of claim 3, wherein the component (A) comprises one or more epoxidized polypropylene oxides.

17. The 2-component adhesive of claim 3, wherein the component (B) comprises one or more bisphenol A epoxides.

18. The 2-component adhesive of claim 3, wherein component (C) comprises bisphenol A.
